(19) United States
(12) Patent Application Publication
(10) Pub. No.: US 2015/0266568 A1
(43) Pub. Date: Sep. 24, 2015

(54) ELECTROMECHANICAL BRAKE ACTUATOR WITH PARK BLOCKING FOR AIRCRAFT

(71) Applicant: MESSIER-BUGATTI-DOWTY, Velizy Villacoublay (FR)

(72) Inventors: Eric EVENOR, Velizy Villacoublay (FR); Nathanael RICHARD, Velizy Villacoublay (FR); Guillaume DURAND, Velizy Villacoublay (FR)

(73) Assignee: MESSIER-BUGATTI-DOWTY, Velizy Villacoublay (FR)

(21) Appl. No.: 14/644,316

(22) Filed: Mar. 11, 2015

(30) Foreign Application Priority Data
Mar. 24, 2014 (FR) 14 52467

(51) Int. Cl. B64C 25/44; F16D 65/16

(52) U.S. Cl. CPC B64C 25/44; F16D 65/16; F16D 2121/24

(57) ABSTRACT

The invention relates to an electromechanical brake actuator for an aircraft wheel, comprising an electric motor (2) with a stator (3) and a rotor (4), a screw/nut assembly, of which one of the elements is rotationally driven by the motor and the other of the elements is compelled to slide without rotation to selectively exert a force on a stack of discs, the actuator comprising a park blocking member (10) suitable for selectively blocking the rotor of the motor at least when the sliding element exerts a force on the stack of discs. The park blocking member comprises a shuttle (17) that can move between a stable position of blocking of the rotor of the motor and a stable position of freeing the latter under the action of a pulse actuator (22, 24, 25) switching the shuttle from one position to the other, the brake actuator comprising means (9, 18) for forcing the shuttle to the freeing position when the motor of the brake actuator is powered.

The invention relates to an electromechanical actuator for an aircraft brake equipped with a park braking member.

### TECHNOLOGICAL BACKGROUND OF THE INVENTION

Electromechanical actuators for an aircraft brake are known, comprising an electric motor with a stator and a rotor, a screw/nut assembly of which one of the elements is rotationally driven by the motor and the other element is compelled to slide without rotation to selectively exert a force on friction elements, such as a stack of discs. The brake actuator is mounted on a support called crown ring more often than not combining several actuators.

To ensure the immobilization of the aircraft on parking, it is necessary to keep the pressure force even when the motor of the actuator is not powered. To this end, it is known practice to equip the brake actuators with park braking members which make it possible to block the rotor of the motor after a pressure force has been exerted on the stack of discs. The park braking member is generally a power-off brake which blocks the shaft of the motor of the actuator when the member is no longer powered, but which releases it as soon as the motor of the actuator is powered.

This type of park member presents a number of drawbacks. During the use of the actuator, the coil of the park braking member remains powered up which generates electrical consumption and overheating. Moreover, in the case of a transient power outage, the park member generates unwanted friction which reduces the efficiency of the brake actuator. Furthermore, if the coil of the park member fails, the park member remains engaged which generates premature wear of its friction linings and a significant loss of efficiency of the actuator.

### OBJECT OF THE INVENTION

The object of the invention is to propose an electromechanical brake actuator for aircraft, that does not feature the abovementioned drawbacks.

### PRESENTATION OF THE INVENTION

In order to achieve this aim, an electromechanical brake actuator for an aircraft wheel is proposed comprising an electric motor with a stator and a rotor, a screw/nut assembly of which one of the elements is rotationally driven by the motor and the other of the elements is compelled to slide without rotation to selectively exert a force on a stack of discs, the actuator comprising a park blocking member suitable for selectively blocking the rotor of the motor at least when the sliding element exerts a force on the stack of discs. According to the invention, the park blocking member comprises a shuttle that can move between a stable position of blocking of the rotor of the motor and a stable position of freeing the latter under the action of a pulse actuator switching the shuttle from one position to the other, the brake actuator comprising means for forcing the shuttle to the freeing position when the motor of the brake actuator is powered.

Thus, since the shuttle positions are stable, it is no longer necessary to permanently power the park braking member. Only brief pulses are needed to cause the shuttle to pass from one position to the other. Furthermore, in the case of failure of the pulse actuator, the electromechanical brake actuator does not remain blocked by virtue of the forcing means which make it possible to release the rotor of the motor.

### BRIEF DESCRIPTION OF THE FIGURES

The invention will be better understood in light of the following description of a nonlimiting embodiment of the invention, with reference to the figures of the attached drawings among which:

FIG. 1 is a cross-sectional view of the motor block of an electromechanical aircraft brake actuator;

FIG. 2 is a schematic diagram of the operation of the park blocking member with which the motor block of FIG. 1 is equipped;

FIG. 3 is a partial front view showing the shuttle of the park blocking member in the blocking position;

FIG. 4 is a partial front view showing the shuttle of the park blocking member in the freeing position.

### DETAILED DESCRIPTION OF A PARTICULAR EMBODIMENT OF THE INVENTION

The invention is here illustrated in its application to a two-part electromechanical braking actuator, like the actuators illustrated in the document FR 2 877 411. Only the motor block incorporating the park member according to the invention is detailed here. This motor block is intended to be associated with a thruster block comprising a screw/nut assembly, one of these elements being rotationally driven by means of the motor block, and the other of the elements forming the thruster to exert a braking force on a stack of discs.

Obviously, the invention applies also to single-piece actuators incorporating the motor and the thruster member.

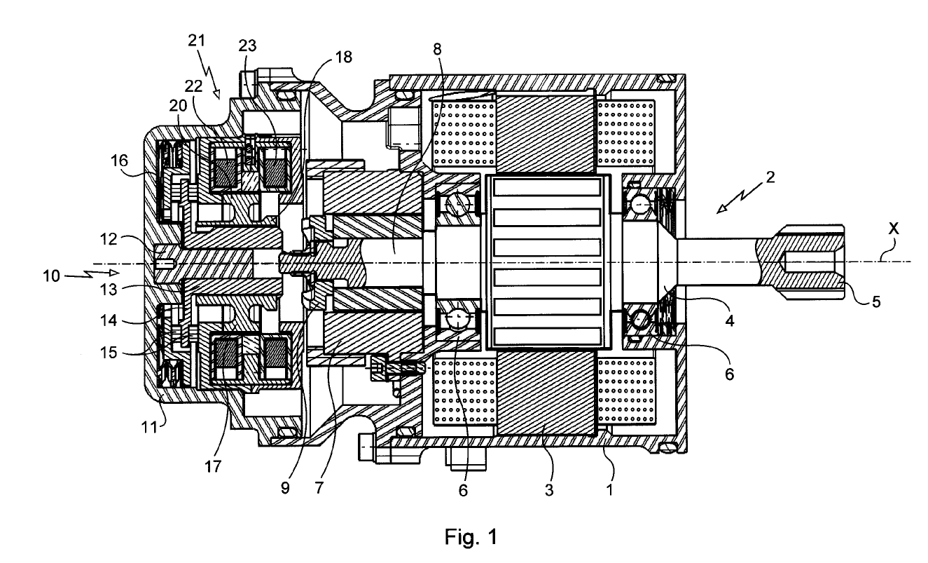

As illustrated in FIG. 1, the motor block of the braking actuator comprises a frame 1 enclosing a motor 2 which comprises a stator 3 and a rotor 4, of which a splined end 5 extends beyond the frame 1 to rotationally drive the rotating element of the screw/nut assembly of the associated block. The rotor 4 is mounted on rolling bearings 6 which define an axis of rotation X of the rotor 4. At the rear of the stator, there is an angular position sensor 7 suitable for supplying an item of information on the angular position of the rotor 4. The position sensor 7 is of annular form and extends around an extension 8 of the rotor 4 which bears, at its end, a cylindrical cam 9.

As can be seen in FIGS. 3 and 4, the cylindrical cam 9 comprises a succession of gentle slopes separated by a steep slope.

A park blocking member 10 is attached to the rear of the motor block. The park blocking member comprises a frame 11 which is attached to the frame 1 of the motor block, and which bears a central guide 12 extending along the axis X and on which a splined sleeve tube 13 is attached to rotate freely. The splined sleeve tube 13 is extended by a plate 14 onto which friction discs 15 are pressed by means of a spring 16 forming a torque limiter. In effect, the splined sleeve tube 13 can rotate only if the torque acting on the splined sleeve tube 13 exceeds a threshold torque C generated by the action of the spring 16 on the friction discs 15.

A shuttle 17 is mounted to slide axially on the splined sleeve tube 13. The splines prevent any relative rotation between the shuttle 17 and the splined sleeve tube 13. The end of the shuttle 17 facing the toothed crown ring 9 bears a toothed crown ring 18. The shuttle also bears a cylindrical bushing 20 made of ferromagnetic material which extends facing a pulse actuator 21 comprising two coils 22 driven into an armature 24 made of ferromagnetic material and also bearing a permanent magnet 25 positioned to generate a magnetic flux which is conducted by the armature 24.

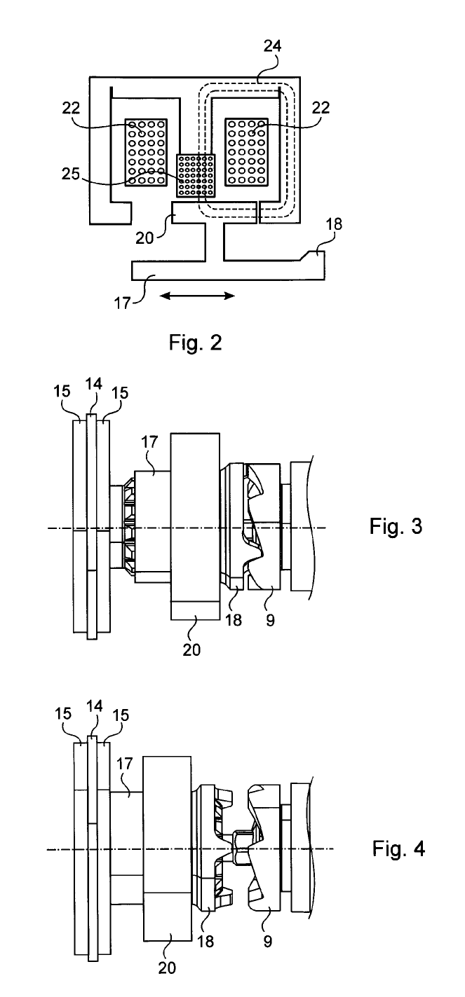

As can be seen more particularly in FIG. 2, the bushing 20, and therefore the shuttle 17 can move between two extreme positions in which the end of the vane comes into abutment against the armature 24. The magnetic flux from the permanent magnet 25 can then be enclosed and tends to keep the shuttle in the abutment position, which is therefore stable. The position illustrated in FIG. 2 corresponds to the position illustrated in FIG. 3, that is to say a position in which the toothed crown ring 18 cooperates with the cylindrical cam 9 to prevent the rotor 4 of the motor from rotating. This is the blocking position. The position illustrated in FIG. 4 corresponds to the freeing position, in which the toothed crown ring 18 and the cylindrical cam 9 are apart from one another. In this position, the shuttle 17 is in abutment against the armature 24, but in a position opposite to that illustrated in FIG. 2. Between the two extreme positions (blocking position and freeing position), there is a position of unstable equilibrium.

To switch the shuttle from one position to the other, it is sufficient to power the coils 22 so that the latter generate a magnetic flux that is sufficient, on the one hand, to counter the flux from the permanent magnet 20 and, on the other hand, to attract the shuttle to the other position. As soon as the shuttle has arrived in position, the power to the coils 22 is cut off, and the shuttle is held in position by virtue of the flux from the permanent magnet. The powering of the coils 22 is very brief and can be likened to a pulse.

It will be noted that, in the blocking position (FIG. 3), a rotation of the motor in a direction in which the teeth of the toothed crown ring 18 cooperate with the steeply-sloped parts of the cylindrical cam 9 is impossible. The toothed crown ring 18 and the cylindrical cam 9 then form rotor blocking means.

However, if the torque applied to the rotor 4 exceeds the threshold torque C, the torque limiter device will start to slip, such that a rotation of the rotor will then be allowed. There are various reasons why the torque might be exceeded in such a way, such as, for example, untimely control of the motor, or even a return of torque to the rotor because of the expansion or the cooling of the discs of the brake after severe braking, when the brake actuators have been blocked by an application of a park force. The torque limiter device makes it possible to protect the entire kinematic chain.

If the shuttle is in the blocking position (FIG. 3) and if, because of a failure, the coils 22 could not function, there then remains the resource of making the rotor 4 of the motor rotate in the other direction, so as to make the teeth of the toothed crown ring 18 cooperate with the gently-sloped parts of the cylindrical cam 9, which forces the teeth to rise on said gently-sloped parts, and therefore moves the shuttle 17 away from the blocking position. The scale of this separation is designed to be sufficient to switch the shuttle to the position of (unstable) equilibrium between the two positions, such that the shuttle 17 is itself displaced towards the freeing position. The shuttle can thus be forced to the freeing position. Furthermore, the torque resistant to the rotation of the rotor 4 is weak, which induces a limited loss of efficiency.

The invention is not limited to what has just been described, but, on the contrary, encompasses any variant falling within the context defined by the claims. In particular, it is possible to place the toothed crown ring on the rotor and the cylindrical cam on the shuttle. More generally, it will be possible to use any other means ensuring both a blocking in one direction of rotation of the rotor, and a forcing of the shuttle to the freeing position, when the rotor rotates in the other direction, such as, for example, two cylindrical cams with similar profiles. Finally, any other position stabilizing device and any other pulse actuator will be able to be used to make the shuttle pass from one position to the other, such as, for example, a bistable spring device associated with a pivoting cam causing the shuttle to pass from one position to the other.

1. Electromechanical brake actuator for an aircraft wheel, comprising an electric motor (2) with a stator (3) and a rotor (4), a screw/nut assembly, of which one of the elements is rotationally driven by the motor and the other of the elements is compelled to slide without rotation to selectively exert a force on a stack of discs, the actuator comprising a park blocking member (10) suitable for selectively blocking the rotor of the motor at least when the sliding element exerts a force on the stack of discs, characterized in that the park blocking member comprises a shuttle (17) that can move between a stable position of blocking of the rotor of the motor and a stable position of freeing the latter under the action of a pulse actuator (22, 24, 25), switching the shuttle from one position to the other, the brake actuator comprising means (9, 18) for forcing the shuttle to the freeing position when the motor of the brake actuator is powered.

2. Electromechanical brake actuator according to claim 1, in which the shuttle is held in one or other of the positions by means of a permanent magnet (25) generating a magnetic flux channelled by an armature (24) defining a magnetic path enclosed by a portion (20) of the shuttle (17).

3. Electromagnetic brake actuator according to claim 1, in which the pulse actuator (22) is suitable for generating a magnetic flux which counters that of the permanent magnet and which causes the shuttle to pass from one position to the other.

4. Electromagnetic brake actuator according to claim 1, in which the shuttle and the rotor bear, for one, a toothed crown ring (18) and, for the other, a cylindrical cam (9) comprising portions with gentle slope alternating with portions with steep slope, forming both blocking means preventing the rotation of the rotor in one direction, and means for forcing the shuttle to the freeing position, in case of rotation of the rotor in another direction.

5. Electromechanical brake actuator according to claim 1, in which the shuttle is mounted to slide without rotation on a splined sleeve tube (13) which is itself rotationally immobilized by a torque limiter device (14, 15, 16) designed to allow a rotation of the sleeve tube and therefore of the shuttle if the torque imposed on the shuttle by the rotor of the motor exceeds a threshold torque.
